(19) United States
(12) Patent Application Publication
(10) Pub. No.: US 2019/0043019 A1
(43) Pub. Date: Feb. 7, 2019

(54) Intelligent Agent to Optimize Connection Methods of Voice Transmissions

(71) Applicant: Gregory Thomas Malley, Los Altos Hills, CA (US)

(72) Inventor: Gregory Thomas Malley, Los Altos Hills, CA (US)

(21) Appl. No.: 15/888,971

(22) Filed: Feb. 5, 2018

Related U.S. Application Data
(63) Continuation of application No. 15/651,959, filed on Jul. 17, 2017.

(51) Int. Cl. G06Q 10/10; H04L 12/58

(52) U.S. Cl. CPC G06Q 10/1095; H04L 51/18; H04L 51/38; H04L 51/046

(57) ABSTRACT

A machine learning based software algorithm and application designed to analyze and optimize phone calls in order to successfully establish a communications link between parties. The algorithm uses personal relationships and actual patterns of communication between contacts to determine the proper scheduling of calls to optimize the probability of successful connections via a phone call.

### SPECIFICATION

This application is a continuation in part of Ser. No. 15/651,959 dated Jul. 17, 2017 which claims priority to provisional application filed on Jul. 17, 2016.

### TERMS

Phone call or call equals voice transmission.

### BACKGROUND OF THE INVENTION

The present invention is in the technical field of Internet Software. More particularly, the present invention is in the technical field of Machine Learning based Digital Assistants. More particularly, the present invention is in the technical field of Machine Learning based Digital Assistants installed on ‘Smart Phones’. More particularly, the present invention is in the technical field of Machine Learning based Digital Assistants installed on ‘Smart Phones’ that manage voice transmissions by phone call as it relates to connecting, prioritizing, arranging, and scheduling. This methodology is applied to making a successful voice transmission to the intended recipient and to establish a connection with an intended recipient when phone call attempts were unsuccessful.

Currently, when people attempt to call one another the connection is often unsuccessful. To increase the chance of success, people must manually coordinate with one another via text or email or calendars to manually schedule a phone call. Further, when phone calls are unscheduled, people must manually synchronize with one another to successfully establish a phone call with one another. A person may leave a voicemail message asking that the other party return the call. Frequently, the return call goes to voicemail. The person returning the call leaves a voicemail message for the person who originally called them. People refer to this a phone tag. The process is tedious and time consuming, and highly manual in nature. Further, there are now a variety of methods and technologies to establish communications between parties, and manual decisions must be made as to which method is optimal to successfully establish communications between parties.

### SUMMARY OF THE INVENTION

The present invention is a software algorithm and application utilizing artificial intelligence, or machine learning, designed to analyze and optimize data in order to successfully establish a communications link between the two parties that are attempting to reach one another. The algorithm processes the making and receiving of call requests, monitors all incoming phone traffic, analyzes personal information related to the parties involved in the phone call attempt, and prioritizes and schedules contemplated or missed phone calls automatically based on the results of the analysis, including the processing of calls contemplated in the form of a list. Further, the adaptive nature of the analysis continually refines the prioritization and optimization of the phone calls to be returned without manual intervention by the user. In one embodiment, the communications device of the person who initiates the call requests manual confirmation that the call should be made at the scheduled time.

The algorithm uses personal relationships and actual patterns of communication to determine the proper scheduling of calls to optimize successful connections via a phone call. Unlike other algorithms and software applications, which typically depend on a calendar and other organizational applications, this algorithm understands the nature of the relationships of people by analyzing their conversations in order to properly prioritize follow up communications in a manner that maximizes the probability that the follow up communication will be successful.

### BRIEF DESCRIPTION OF THE DRAWINGS

FIG. 1 represents the general workflow and logic of the application.

FIG. 2 represents the machine learning analysis and prioritization process and the various factors that determine the scheduling of conversations.

FIG. 3 represents the kinetic actions of making and receiving calls while the application monitors and performs the automatic synchronization and scheduling of calls based on the artificial intelligence entity.

FIG. 4 is a scenario that illustrates the interactions between four users initiating and receiving calls and the subsequent scheduling results to synchronize calls to ensure a successful completion of the instance by either a successful phone call or marking it otherwise completed. Missed calls are dynamically rescheduled.

FIG. 5 represents the coordination of prospective recipients of a voice transmission between multiple parties such that the calls are scheduled at a mutually acknowledged time.

### DETAILED DESCRIPTION OF THE INVENTION

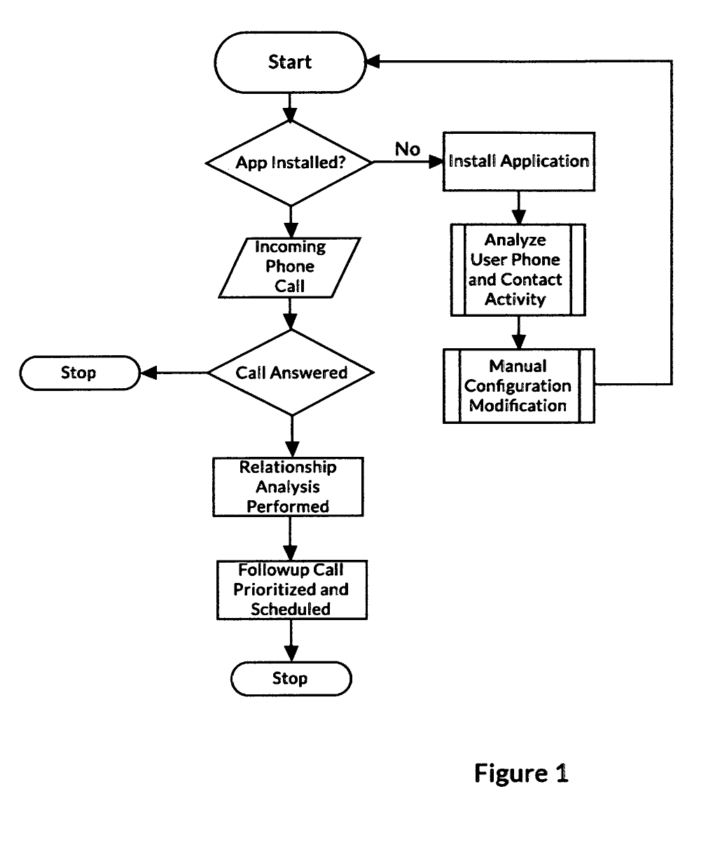

Referring now to the invention in more detail, in FIG. 1 there is shown the initial application installation, application configuration analysis and the application dynamic machine learning logic loop that iterates persistently while monitoring user phone activity.

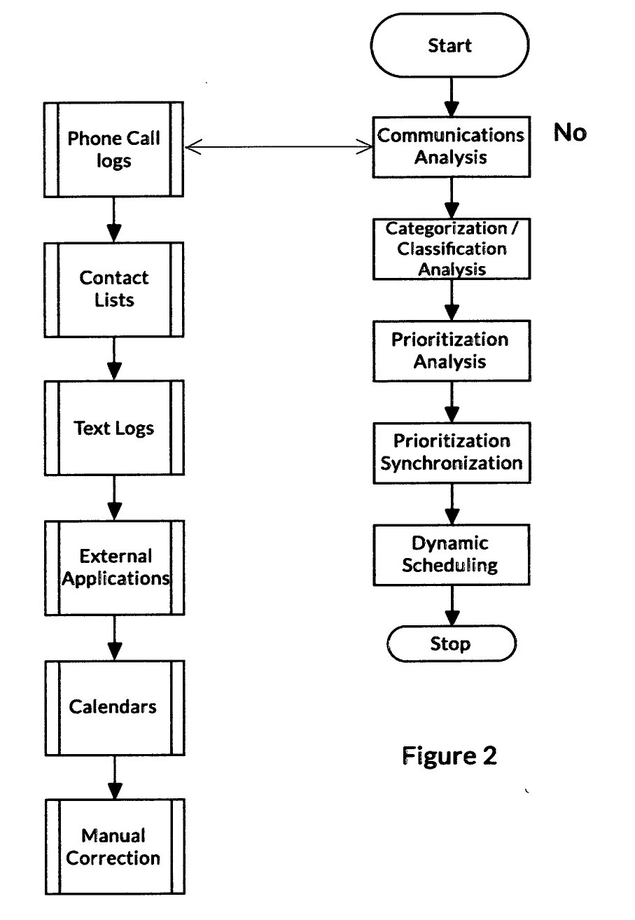

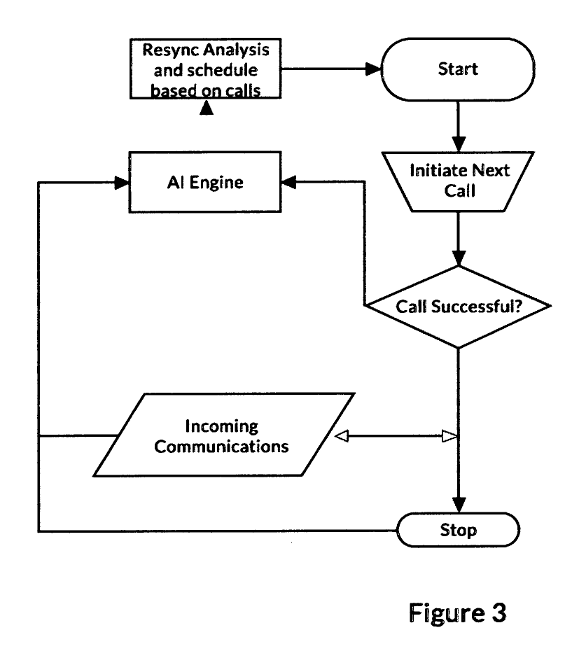

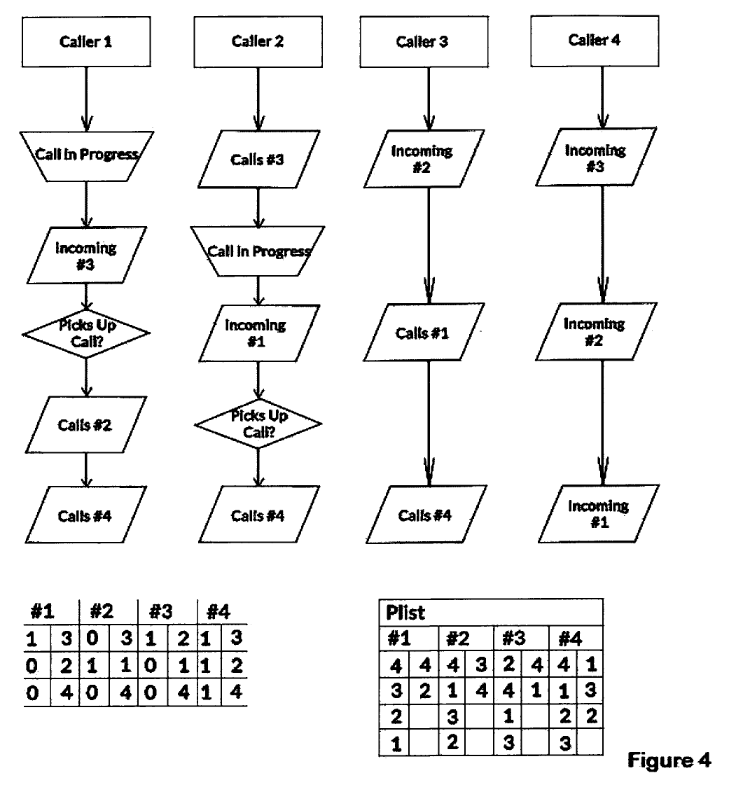

In FIG. 2, calendars, external applications, text logs, contact lists, and phone call logs, are analyzed, categorized, classified, prioritized and synchronized. Calls are then dynamically scheduled. In FIG. 3, a call is initiated. In the event that the a connection between the caller initiator and the call recipient is not successfully, the artificial intelligence engine schedules the call for another time. Calls which come in while a call is in progress are scheduled by the artificial intelligence engine between user devices. FIG. 4 is a representation of users initiating and receiving calls due to synchronization and thus successful scheduling. Missed calls are dynamically rescheduled.

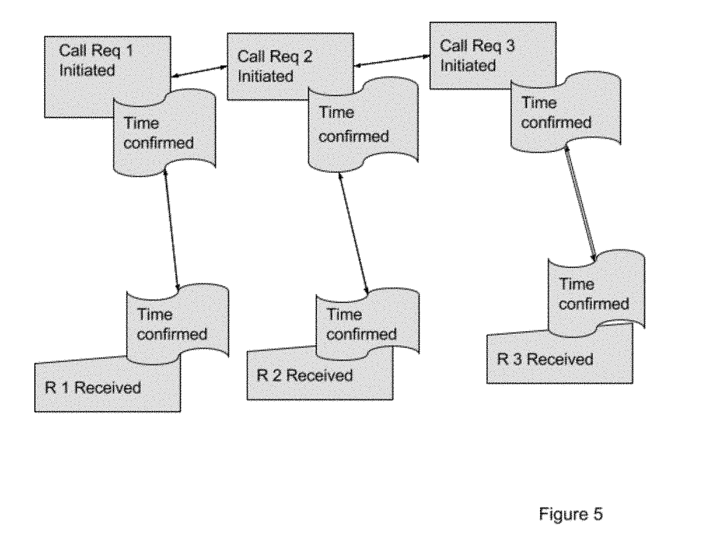

In FIG. 5, initiation and connection with a number of phone call recipients is desired. Call requests are initiated from phone numbers in a list. Communication devices associated with the contact numbers receive and process call requests via the algorithm of the present invention. Call times are coordinated and scheduled between multiple devices. Scheduled calls are made when availabilities are determined from current sources and previous calling behaviors. The algorithm may propose and schedule connection times between devices which users may reschedule manually or dynamically upon review.

### Detailed Description of One Embodiment

A list of calls is contemplated. Phone numbers are selected from a list of contacts. The device for making voice transmissions, such as a phone, initiates the calls by transmitting text messages to other devices capable of receiving voice transmissions. Call times are scheduled between devices based on information available from calendars, external applications, text logs and prior calling behavior. Call times are displayed to users who may send out notifications to dynamically reschedule. A user will start their morning with a list of the calls they intend to make already scheduled. Calls are scheduled around times which the user has blocked out such times for events such as having lunch or participation in meetings. The algorithm can select to coordinate and schedule a call between multiple parties in addition to calls between two parties.

1. A method using an algorithm to design, analyze and optimize voice transmissions in order to successfully establish a communications link between parties that are attempting to connect with one another.

2. The method of claim one wherein the algorithm monitors all incoming phone traffic, analyzes personal information related to the parties involved in the phone call attempt, and prioritizes and schedules phone calls automatically based on the results of the analysis.

3. The method of claim one wherein the adaptive nature of the analysis continually refines the prioritization and optimization of the scheduling of phone without manual intervention by the users.

4. The method of claim one wherein the algorithm uses personal relationships and actual patterns of communication to determine the scheduling of calls to optimize successful connections via a communications device.

5. The method of claim one wherein the algorithm understands the nature of the relationships of users by analyzing their conversations in order to prioritize communications in a manner that maximizes the probability that the event of the communication will occur.

6. The method of claim one wherein the algorithm reschedules calls for a time agreed upon by intended participants either through manual intervention or by the artificial intelligence engine.

7. The method of claim one wherein the algorithm suggests calls based on a list, a calendar, or other information source. Data from calendars, external applications, text logs, contact lists, phone call logs, and other data sets are analyzed, categorized, classified, prioritized and synchronized for the purpose of scheduling.

8. A method wherein the algorithm schedules voice transmissions at specific times between various communication devices.

9. The method of claim two wherein the algorithm schedules voice transmissions at specific times between various communication devices from a list.

10. The method of claim two wherein the algorithm coordinates voice transmissions between various communication devices from a list to determine a calling schedule.

11. The method of claim two wherein the algorithm schedules and dynamically reschedules calls at specific times between various communication devices based on changing inputs from users.

12. The method of claim two wherein the algorithm schedules calls for a specific time period from a list of people the user intends to call.

13. The method of claim two wherein the algorithm reschedules missed calls which were not cancelled.

14. The method of claim two wherein the algorithm suggests calls and then schedules calls with prospective recipients selected by the call initiator.

15. The method of claim two wherein the algorithm schedules calls before or after a null period during which no calls are allowed to be scheduled.

16. The method of claim two wherein the algorithm schedules a phone call among multiple participants.

17. The method of claim two wherein the algorithm reschedules a phone call between one or more participants.

18. The method of claim two wherein the algorithm may propose and schedule connection times between devices with allowance for users to reschedule manually or dynamically, upon review by the users.

19. The method of claim two wherein the algorithm schedules a call for a user who selects to choose the option of scheduling a call in preference to utilizing a voicemail system to leave a message.
